(19) United States
(12) Patent Application Publication
(10) Pub. No.: US 2016/0097353 A1
(43) Pub. Date: Apr. 7, 2016

(54) Air filter for internal combustion engines

(71) Applicant: Corneliu Birtok-Baneasa, Jud. Hunedoara (RO)

(72) Inventor: Corneliu Birtok-Baneasa, Jud. Hunedoara (RO)

(21) Appl. No.: 14/121,674

(22) Filed: Oct. 6, 2014

(51) Int. Cl. F02M 35/024; B01D 46/00; F02M 35/02

(52) U.S. Cl. CPC F02M 35/02416; F02M 35/0201; B01D 46/0045

(57) ABSTRACT

An air filtration system comprises an airflow inverter valve, an internal diffuser and a cylindrical filtration element positioned between the airflow inverter valve and the internal diffuser. A frustoconical external diffuser is joined to the airflow inverter valve so as to at least partly surround the filtration element. If desired, the airflow inverter valve and the external diffuser may be built as a single monolithic member. In one example, the airflow inverter valve, internal diffuser, filtration element and external diffuser each have a central axis of rotation aligned along a common central axis of the air filtration system.

### FIELD OF THE INVENTION

The present invention relates to air filters, particularly to air filters used in internal combustion engines.

### DESCRIPTION OF THE RELATED ART

The volume of filtered air available for powering internal combustion engines is critical to engine performance. Typically, the space allocated for vehicle combustion air filtration is limited according to vehicle geometry and the size of the engine compartment.

A related problem with conventional air filtration is encountered in the practical deployment of equipment by a commercial vendor. Problems arise from the rather large inventory of air filtration systems required to be produced, in view of the number of different vehicle designs offered by a vehicle manufacturer. Space requirements often dictate the orientation of air filter equipment, and this directly and oftentimes negatively affects air filtration performance. At the very least, a number of different air filtration equipment designs is required to satisfy vehicle demands.

Accordingly, air filtration equipment of flexible design and improved performance is still being sought. Further, air filtration systems that allow ready adaptability for a wide variety of vehicles are also being sought.

### SUMMARY OF THE INVENTION

The present invention provides a novel and improved air filtration system for use with internal combustion engines in which an air filtration system providing filtered air to an internal combustion engine is fitted to the engine intake manifold. The air filtration system comprises an airflow inverter valve, an internal diffuser, a cylindrical filtration element that is positioned between the airflow inverter valve and the internal diffuser and a frustoconical external diffuser joined to the airflow inverter valve so as to at least partly surround the filtration element. If desired, the airflow inverter valve and the external diffuser may be built as a single monolithic member.

In a first example of an air filtration system according to the principles of the present invention, the air filtration system comprises an airflow inverter valve and an internal diffuser. A filtration element is held captive between the airflow inverter valve and the internal diffuser; and an external diffuser is joined to the airflow inverter valve so as to at least partly surround the filtration element. When installed in a vehicle, the airflow inverter valve faces forward and receives oncoming air flow.

In a second example of an air filtration system according to the principles of the present invention, a recovery diffuser is provided adjacent the airflow inverter valve, and the airflow inverter valve defines at least one opening allowing air flow deflected by the recovery diffuser to reach the filtration element. When installed in a vehicle, the recovery diffuser faces crosswise within the engine compartment of the vehicle so as to receive oncoming air flow.

In a third example of an air filtration system according to the principles of the present invention, a recovery diffuser is provided adjacent the airflow inverter valve. The airflow inverter valve defines at least one opening allowing air flow deflected by the recovery diffuser to reach the filtration element. When installed in a vehicle, the internal diffuser faces forward within the engine compartment of the vehicle so that the external diffuser receives oncoming air flow.

In a fourth example of an air filtration system according to the principles of the present invention, a recovery diffuser is provided adjacent the airflow inverter valve. The airflow inverter valve defines at least one opening allowing air flow deflected by the recovery diffuser to reach the filtration element. When installed in a vehicle, the internal diffuser faces in a downward direction.

In one example of an air filtration system according to the principles of the present invention, the airflow inverter valve, internal diffuser, filtration element and external diffuser each have a central axis of rotation. In a further example, the central axes of rotation of the airflow inverter valve, internal diffuser, filtration element and external diffuser are each aligned along a common central axis of the air filtration system.

In a further example, an air filtration system according to the principles of the present invention further comprises a cap member carried by the airflow inverter valve, the recovery diffuser is removably joined to the cap member; and the cap member has a central axis of rotation aligned along the common central axis of the air filtration system.

### BRIEF DESCRIPTION OF THE DRAWINGS

In the drawings, which comprise a portion of this disclosure:

FIG. 1 is an exploded cross-sectional view of a first embodiment of an air filtration system illustrating certain aspects of the present invention;

FIGS. 2a-2d are schematic cross-sectional views of the first embodiment of an air filtration system illustrating certain aspects of the present invention;

FIGS. 3a and 3b are perspective views of air filtration systems illustrating certain aspects of the present invention;

FIG. 4a is a schematic cross-sectional view of an air filtration system illustrating certain aspects of the present invention;

FIG. 4b is a top elevational schematic view of the air filtration system of FIG. 4a shown installed in a vehicle;

FIG. 5a is a schematic cross-sectional view of an air filtration system illustrating certain aspects of the present invention;

FIG. 5b is a top elevational schematic view of the air filtration system of FIG. 5a shown installed in a vehicle;

FIG. 6a is a schematic cross-sectional view of an air filtration system illustrating certain aspects of the present invention;

FIG. 6b is a top elevational schematic view of the air filtration system of FIG. 6a shown installed in a vehicle;

FIG. 7a is a schematic cross-sectional view of an air filtration system illustrating certain aspects of the present invention; and

FIG. 7b is a top elevational schematic view of the air filtration system of FIG. 7a shown installed in a vehicle.

### DESCRIPTION OF THE PREFERRED EMBODIMENTS

The invention disclosed herein is, of course, susceptible of embodiment in many different forms. Shown in the drawings and described herein in detail are the preferred embodiments of the invention. It should be understood, however, that the present disclosure is an exemplification of the principles of the invention and does not limit the invention to the illustrated embodiments.

For ease of description, air filtration systems embodying the present invention are described herein in their usual assembled position as shown in the accompanying drawings and terms such as front, rear, upper, lower, horizontal, longitudinal, etc., may be used herein with reference to this usual position. However, the air filtration systems may be manufactured, transported, sold, or used in orientations other than that described and shown herein.

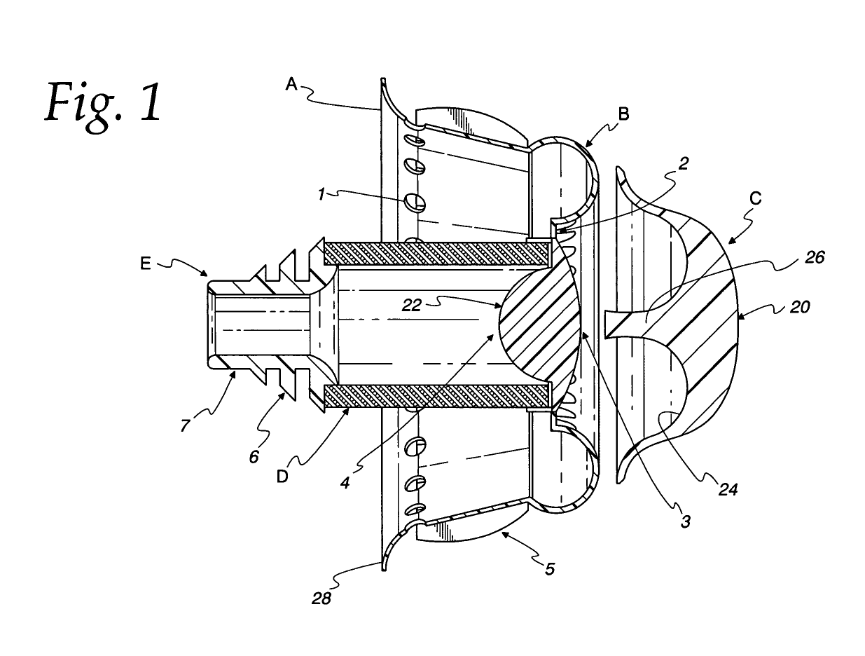

Referring now to FIG. 1, an air filtration system embodying certain aspects of the present invention is generally indicated at 20. Included is an external diffuser A, an airflow inverter valve B and a recovery diffuser C. While not required, it is generally preferred that external diffuser A and airflow inverter valve B are formed as parts of a common structural body. As can be seen in the drawings, external diffuser A has a generally frustoconical shape with a flared larger bottom end 28 and an opposed smaller upper end where airflow inverter valve B is located. Airflow inverter valve B has a concave inner surface 24 facing the bottom end of external diffuser A. The common structural body may be formed from virtually any readily available material and is preferably made from sheet metal.

Airflow inverter valve B has an opposed upper end defining a central bore which receives a cap member 22. A series of recovery holes 2 surrounds cap member 22, allowing air flow communication with the interior of external diffuser A. A generally cylindrical filtration element D comprising micro porous cardboard or fabric includes an upper end engaging cap member 22. An internal diffuser E engages the lower end of filtration element D, cooperating with cap member 22 to hold filtration element D in a fixed position within air filtration system 20. Cap member 22 has an upper targeting surface 3 which guides air flow entering the gap between recovery diffuser C and airflow inverter valve B. Cap member 22 also has an opposed lower concentrating surface 4 facing toward the interior of filtration element D, concentrating air flow within the upper end of filtration element D.

As can be seen in FIG. 1, external diffuser A defines a series of through holes 1 adjacent its flared bottom end 28. A plurality of fins 5 is carried on the outer surface of external diffuser A. The bottoms of fins 5 are preferably located adjacent holes 1. Internal diffuser E has a plurality of directing fins 6 carried on its outer surface. Internal diffuser E has an enlarged flared upper end in contact with the bottom end of filtration element D and an opposed generally cylindrical lower end 7 which provides ready connection to the air intake manifold of an internal combustion engine.

With further reference to FIG. 1, recovery diffuser C has a downwardly facing annular cavity defined by concave walls 24. A central post 26 is located at the center of the annulus. Not shown in FIG. 1 is an adjusting bolt extending between central post 26 and targeting surface 3 of cap 22. The lower end of recovery diffuser C is outwardly flared to provide positive closing contact with the upper rounded surface of inverter valve B. When placed in operation, the cylindrical end 7 of internal diffuser E is fitted to the air intake manifold of an internal combustion engine. As will be seen, air filtration system 20 provides a number of enhancements to the air flow exiting the air filtration system.

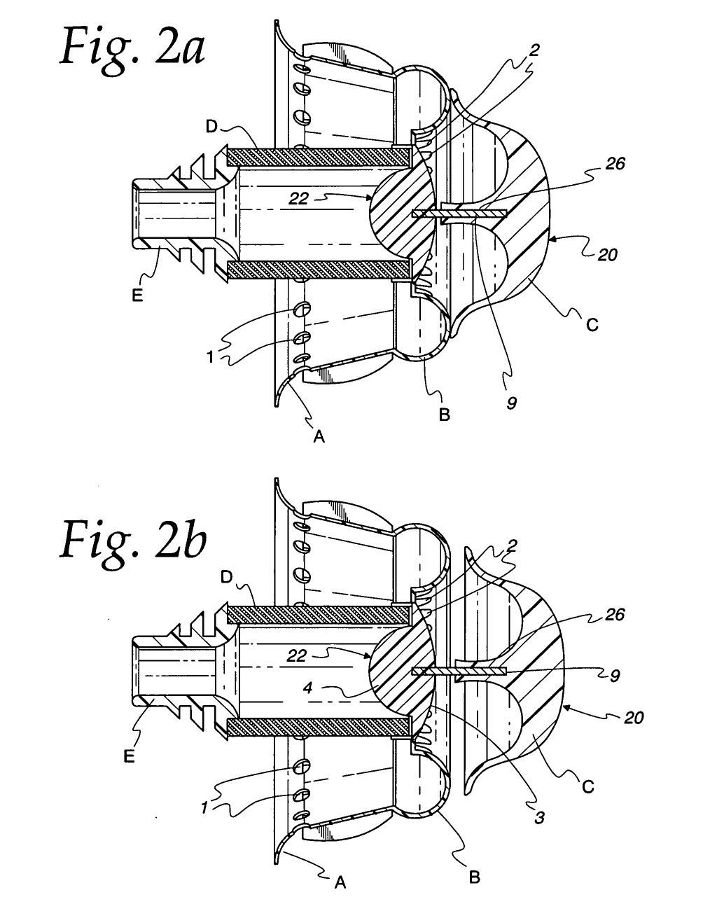

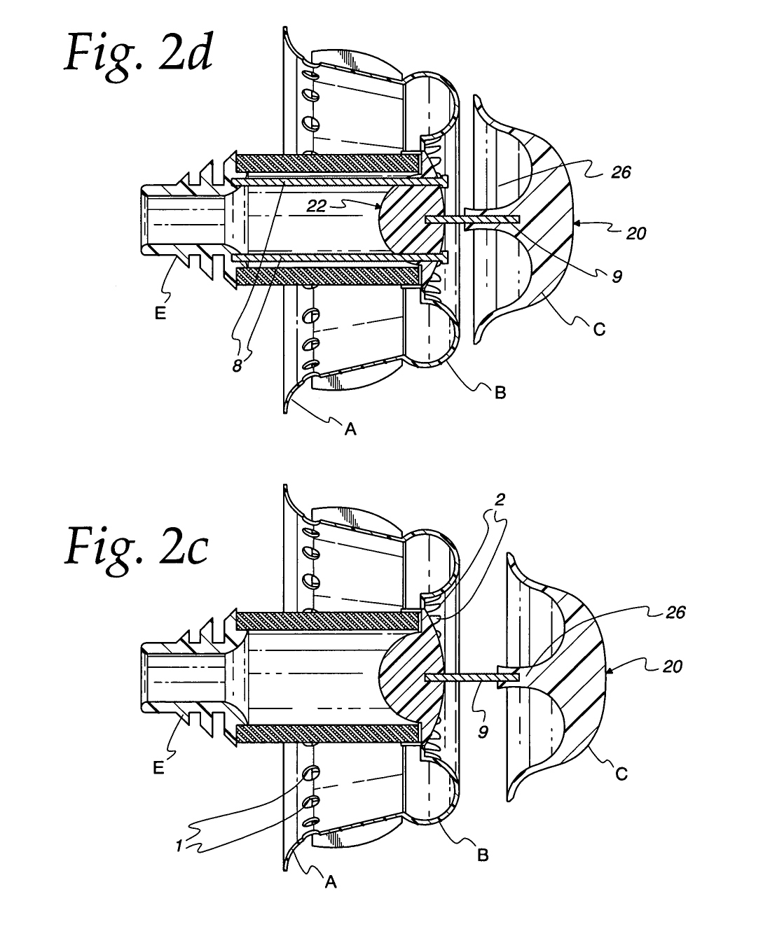

Referring now to FIGS. 2a-2d and initially to FIG. 2a, an adjusting bolt 9 is shown, removably attaching recovery diffuser C to cap 22 carried by airflow inverter valve B. FIG. 2a shows air filtration system 20 in a closed condition, with recovery diffuser C in closing engagement with airflow inverter valve B. This configuration effectively blocks air flow through recovery holes 2 located in airflow inverter valve B, thus blocking air flow from entering the interior of external diffuser A. In the arrangement of FIG. 2a, all airflow exiting air filtration system 20 enters the air filtration system through holes 1.

Referring now to FIG. 2b, recovery diffuser C is shown in an elevated position with its flared lower end spaced above the outer rounded surface of airflow inverter valve B. This allows air flow to pass along the bottom end of recovery diffuser C so as to enter recovery holes 2 formed in the radially inner portion at the upper end of airflow inverter valve B. This air flow thereby enters the interior of external diffuser A and is free to pass through filtration element D. Air flow passing through holes 1 in external diffuser A also enters the interior of external diffuser A and is free to pass through filtration element D.

Referring now to FIG. 2c, adjusting bolt 9 is shown fully extended, removably attaching recovery diffuser C to cap 22 carried by airflow inverter valve B. FIG. 2c shows air filtration system 20 in a fully open condition, with recovery diffuser C spaced apart, above airflow inverter valve B. This configuration allows full air flow through recovery holes 2 located in airflow inverter valve B, thus permitting air flow to enter the interior of external diffuser A. In the arrangement of FIG. 2c, airflow exiting air filtration system 20 also enters the air filtration system through holes 1, in addition to the air flow through recovery holes 2. Adjusting bolt 9 can take virtually any form desired, and in the preferred embodiment comprises a threaded rod, allowing recovery diffuser cap C to unscrew in the manner indicated so as to allow full air flow through the upper end of airflow inverter valve B.

Referring now to FIG. 2d, a pair of connecting rods 8 secure filtration element D within air filtration system 20. The upper ends of connecting rods 8 pass through cap 22. As can be seen in the Figure, cap 22 defines a pocket-like land for receiving the upper end of filtration element D, thus cooperating with connecting rods 8 to provide a firm seating for filtration element D. The lower ends of connecting rods 8 are received by internal diffuser E. The upper end of internal diffuser E defines a pocket-like land for receiving the lower end of filtration element D, so as to cooperate with connecting rods 8 to provide a firm seating for filtration element D. When tightened, connecting rods 8 compressively engage filtration element D securely holding the filtration element in a defined fixed position within air filtration system 20. Connecting rods 8 may be of virtually any construction known today, and preferably comprise threaded rods or bolts.

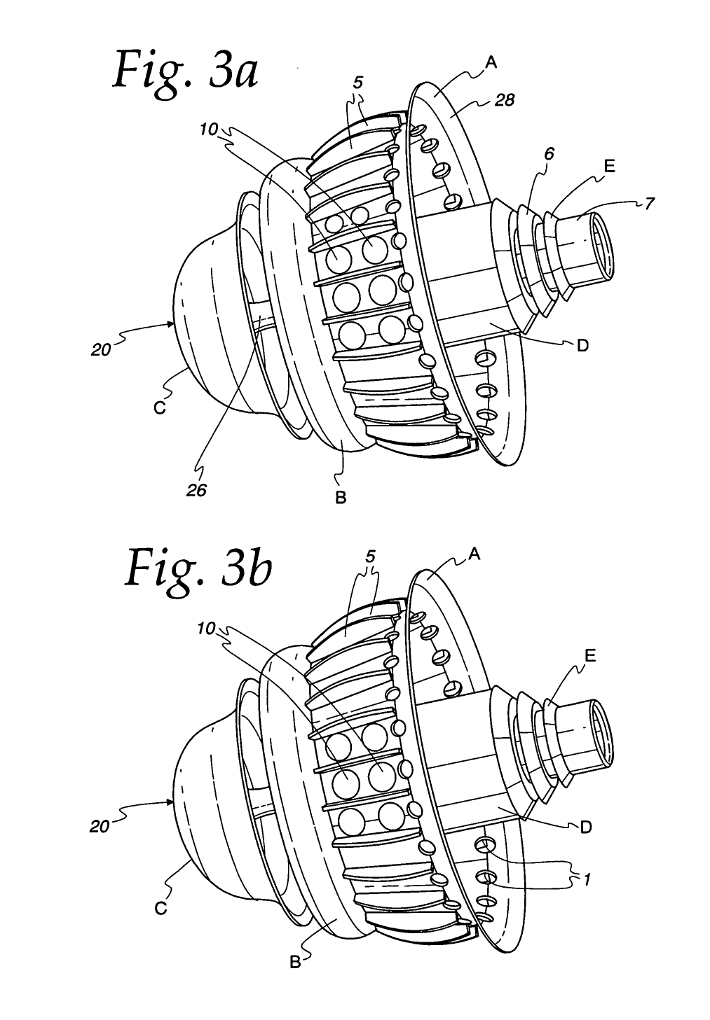

Referring now to FIGS. 3a-3b and initially to FIG. 3b, air filtration system 20 is shown in an exploded perspective view, with recovery diffuser C shown suspended above airflow inverter valve B. As mentioned above, airflow inverter valve B and external diffuser A are preferably formed from a single monolithic body. The lower end 28 of external diffuser A is outwardly flared and a series of through holes 1 are located adjacent lower end 28. As shown, a series of holes 10 are located adjacent and above holes 1. Holes 10 are located between fins 5. Although not required, holes 10 are configured as large as possible so as to cover the largest portion of the frustoconical wall of external diffuser A as possible. According to one aspect of the present invention, holes 10 may be configured as through holes, allowing the maximum air flow into the interior of external diffuser A. In certain applications, this may be too much air flow to accommodate desired engine performance, and accordingly, one or more holes 10 may be configured so as to be semiperforate.

Referring now to FIG. 3a, central post 26 extends from the center interior of recovery diffuser C to provide convenient mounting of recovery diffuser C to airflow inverter valve B. As mentioned, recovery diffuser C is preferably removably attached to airflow inverter valve B so as to allow convenient adjustment of the airflow gap between recovery diffuser C and airflow inverter valve B. Removal of recovery diffuser C from airflow inverter valve B also allows convenient access to connecting rods 8, to allow disassembly of air filtration system 20, thus permitting ready removal of filtration element D. A plurality of directing fins 6 are located on the outer body of internal diffuser E, adjacent and slightly above cylindrical pipe section 7 of internal diffuser E. Directing fins 6 guide air flow passing across internal diffuser E.

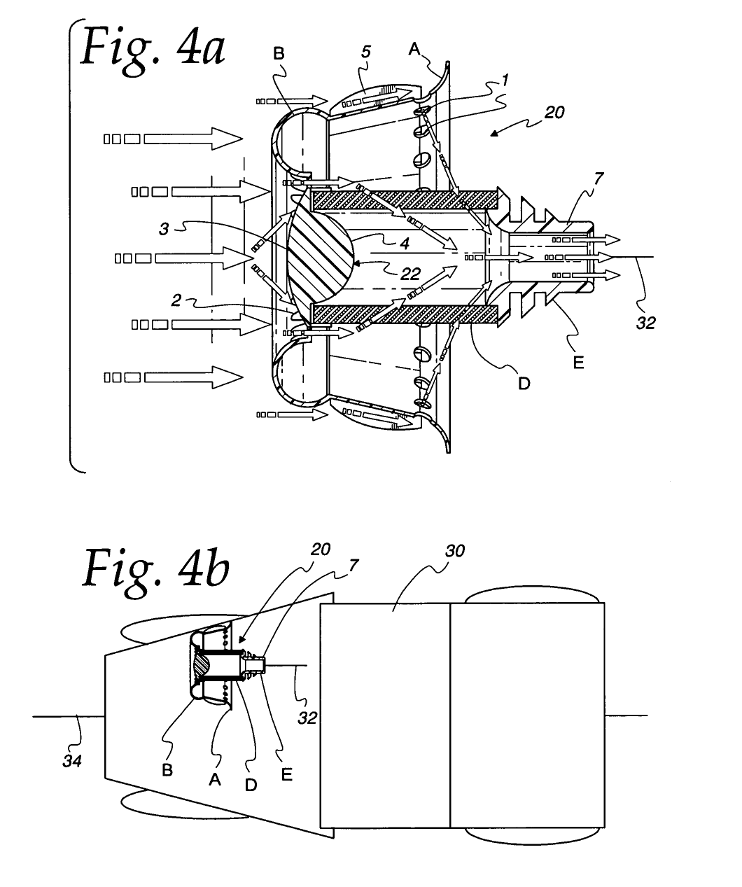

Referring now to FIGS. 4a-4b and initially to FIG. 4a, air filtration system 20 is shown in one example of a practical installation of the air filtration system on a motor vehicle 30 (see FIG. 4b). In this embodiment, recovery diffuser C is omitted because it would effectively block air flow through recovery holes 2, thus significantly reducing air flow entering the internal combustion engine. In the arrangement shown, the principal elements of air filtration system 20 each have a preferred central axis of rotation 32. That is, external diffuser A, airflow inverter valve B, filtration element D, cap member 22 and internal diffuser E each have a respective central axis of rotation. Although not required, the central axes of rotation of external diffuser A, airflow inverter valve B, filtration element D, cap member 22 and internal diffuser E are all aligned along a common central axis of rotation 32 of air filtration system 20. In the arrangement shown in FIGS. 4a-4b, the common central axis of rotation 32 of air filtration system 20 is aligned generally parallel to the central axis 34 of vehicle 30. Further, air filtration system 20 is preferably arranged so that its airflow inverter valve B is upstream of the remainder of the air filtration system 20.

Accordingly, as indicated by the arrows in the left hand portion of FIG. 4a, oncoming air flow impinges upon airflow inverter valve B so as to enter recovery holes 2, thus gaining access to the interior of external diffuser and hence, to air filtration element D. As indicated in FIG. 4a, a portion of the oncoming air flow travels along the outside of airflow inverter valve B, so as to be guided along the outer surface of external diffuser A, entering through holes 1 so as to gain access to air filtration element D. Fins 5 serve to collimate the air flow on the outer surface of external diffuser A, thereby enhancing air flow entering through holes 1. Although not shown in FIG. 4b, a plurality of semiperforate or alternatively, through holes 10 may be formed in external diffuser A so as to augment incoming air flow entering air filtration element D. The targeting surface 3 of cap member 22 helps direct air flow toward recovery holes 2, while the opposing surface 4, the concentrating surface of the cap member, helps to direct air flow in the desired direction toward internal diffuser E.

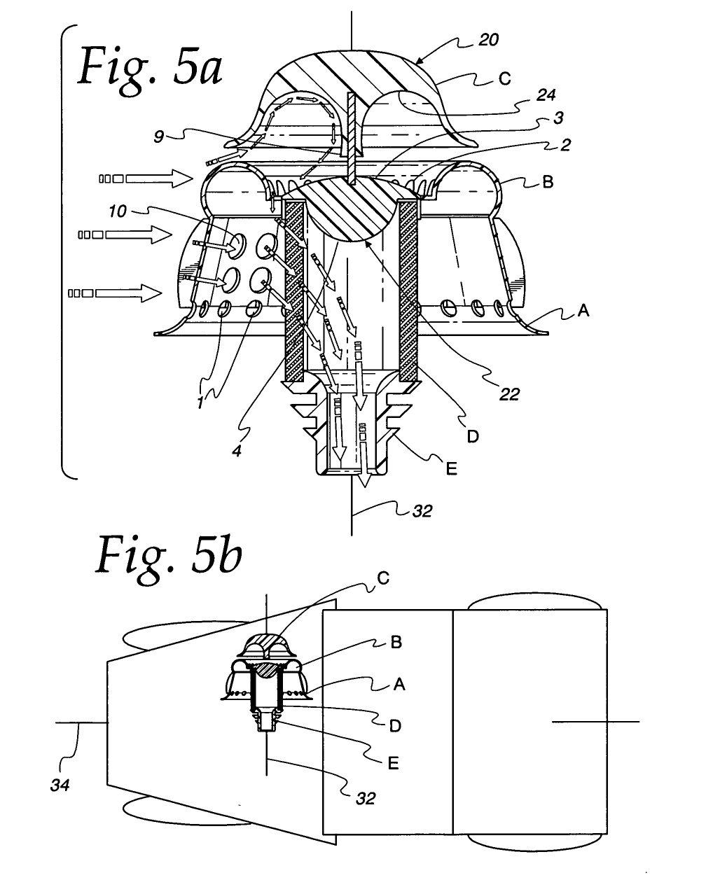

Referring now to FIGS. 5a-5b and initially to FIG. 5a, air filtration system 20 is shown in another example of a practical installation on motor vehicle 30 (see FIG. 5b). In the arrangement shown, the principal elements of air filtration system 20 each have a preferred central axis of rotation. Although not required, the central axes of rotation of external diffuser A, airflow inverter valve B, recovery diffuser C, filtration element D, cap member 22 and internal diffuser E are all aligned along a common central axis of rotation 32 of air filtration system 20. In the arrangement shown in FIGS. 5a-5b, the common central axis of rotation 32 of air filtration system 20 is aligned generally perpendicular to the central axis 34 of vehicle 30 (see FIG. 5b). As indicated in FIG. 5a, oncoming air flow impinges upon the outer surface of external diffuser A and airflow inverter valve B. The rounded outer surface of airflow inverter valve B directs a portion of the air flow to the underside, or interior of recovery diffuser C. The concave generally annular surface 24 deflects air flow entering the gap between recovery diffuser C and air flow inverter valve B toward through recovery holes 2 formed in the central interior of airflow inverter valve B, thus gaining access to filtration element D. The targeting surface 3 of cap member 22 and the opposed concentrating surface 4 of the cap member aid in directing air flow toward internal diffuser E.

As indicated in FIG. 5a, air flow impinging on the outer surface of external diffuser A enters the interior of the external diffuser by passing through holes 1. When greater air flow to the engine is desired, the wall of external diffuser A may be opened by a plurality of holes 10. When maximum added air flow is desired, holes 10 are fully open, to form through holes allowing air flow access to filtration element D. When lesser added air flow is desired, holes 10 are made semiperforate. Incoming air flows entering the interior of external diffuser A combine in air filtration element D so as to pass through internal diffuser E, entering the air intake manifold of the internal combustion engine. If desired, recovery diffuser C can be omitted, thereby reducing the amount of air available to the engine. Without recovery diffuser C, a minimal air flow will enter through recovery holes 2.

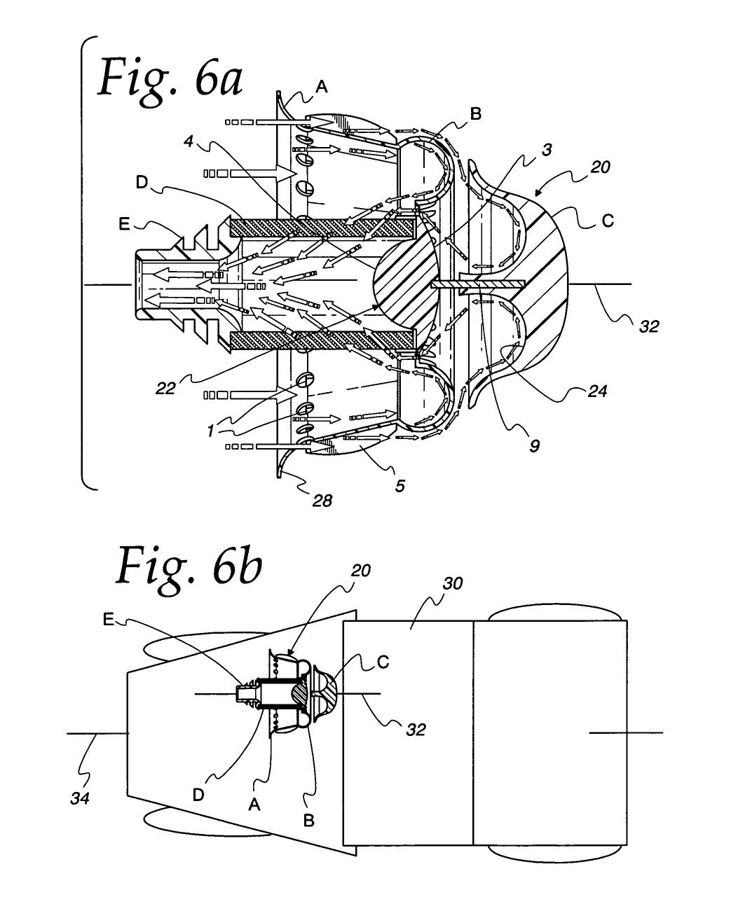

Referring now to FIGS. 6a-6b and initially to FIG. 6a, air filtration system 20 is shown in a further example of a practical installation of the air filtration system on motor vehicle 30 (see FIG. 6b). In the arrangement shown, the principal elements of air filtration system 20 each have a preferred central axis of rotation. Although not required, the central axes of rotation of external diffuser A, airflow inverter valve B, recovery diffuser C, filtration element D, cap member 22 and internal diffuser E are all aligned along a common central axis of rotation, parallel to the central axis of rotation 32 of air filtration system 20. In the arrangement shown in FIGS. 6a-6b, the common central axis of rotation 32 of air filtration system 20 is aligned generally parallel to the central axis 34 of vehicle 30 (see FIG. 6b). Preferably, air filtration system 20 is arranged so that internal diffuser E is located upstream of the remainder of the air filtration system. As indicated in FIG. 5a, oncoming air flow impinges upon the outwardly flared end 28 of external diffuser A.

Although incoming air flow is free to contact air filtration element D, it lacks the directionality needed to pass through the air filtration element. Accordingly, incoming air flow entering the interior of external diffuser A travels past the external diffuser so as to contact the concave surface 24 of recovery diffuser C. This reverses air flow direction, directing air flow to enter filtration element D. With continued reference to FIG. 6a, a portion of incoming air flow passes the outwardly flared end 28 of external diffuser A so as to travel along the outer surface of the external diffuser. Guided by directing fins 5, this air flow travels along the outer surfaces of external diffuser A and airflow inverter valve B so as to enter the gap between recovery diffuser C and airflow inverter valve B. This air flow is guided by concave, preferably annular, surface 24 of recovery diffuser C so as to pass through recovery holes 2 of the airflow inverter valve B, thus gaining flow communication with filtration element D. In this manner, airflow streams are combined and pass through filtration element D so as to travel through internal diffuser E, thereby entering the air intake manifold of the internal combustion engine.

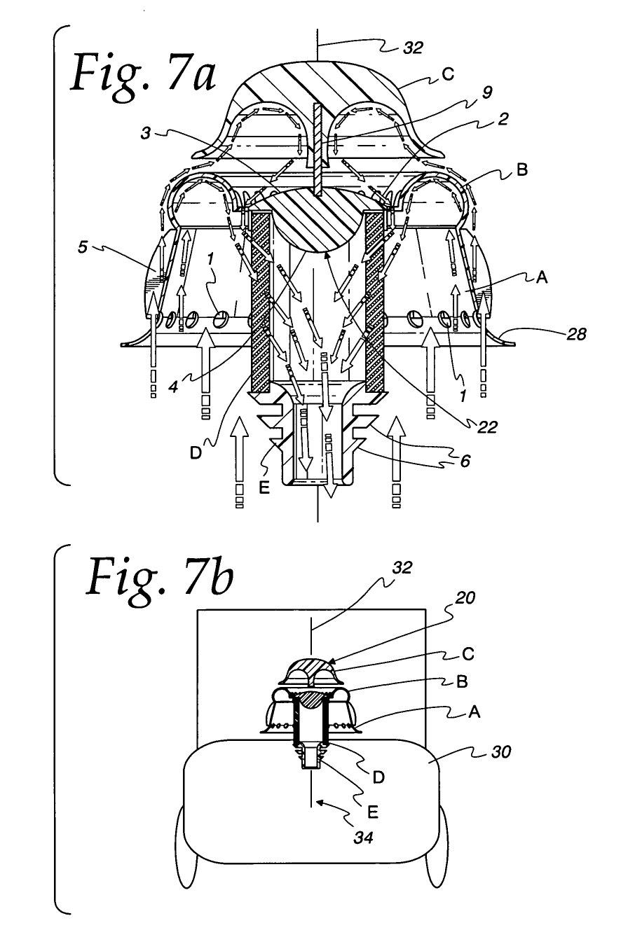

Referring now to FIGS. 7a-7b and initially to FIG. 7a, air filtration system 20 is shown in another example of a practical installation of the air filtration system on motor vehicle 30 (see FIG. 7b). In the arrangement shown, the principal elements of air filtration system 20 each have a preferred central axis of rotation. Although not required, the central axes of rotation of external diffuser A, airflow inverter valve B, recovery diffuser C, filtration element D, cap member 22 and internal diffuser E are all aligned along a common central axis of rotation, perpendicular to the central axis of rotation 32 of air filtration system 20. Preferably, air filtration system 20 is arranged in a generally upright position so that internal diffuser E is located below the remainder of the air filtration system. As indicated in FIG. 7a, oncoming air flow travels over directing fins 5 and also impinges upon the outwardly flared end 28 of external diffuser A. Incoming air flow passing over directing fins 5 is in contact with the outer surface of air filtration element D. However, the air flow lacks the directionality needed to pass through the air filtration element D. As a result, incoming air flow entering the interior of external diffuser A travels past the external diffuser so as to contact the concave surface 24 of recovery diffuser C. This effectively reverses air flow direction, directing air flow to enter filtration element D. A portion of incoming air flow passes the outwardly flared end 28 of external diffuser A so as to travel along the outer surface of the external diffuser.

Guided by directing fins 5, this air flow travels along the outer surfaces of external diffuser A and airflow inverter valve B so as to enter the gap between recovery diffuser C and airflow inverter valve B. Concave, preferably annular surface 24 of recovery diffuser C guides the air flow so as to pass through recovery holes 2 of the airflow inverter valve B, thus placing the air flow in flow communication with filtration element D. Thus airflow streams are combined and pass through filtration element D so as to travel through internal diffuser E, thereby entering the air intake manifold of the internal combustion engine. As mentioned, recovery diffuser C is preferably adjustably connected to airflow inverter valve B by threaded rod 9. Thus, recovery diffuser C can be spaced above airflow inverter valve B so as to form a gap through which air flow can pass toward recovery holes 2. The size of the air gap can be readily adjusted to meet engine air flow requirements. Target surface 3 of cap member 22 and concentrating surface 4 of the cap member help to direct air flow through recovery holes 2 so as to pass through air filtration element D, travelling through internal diffuser E, toward the air intake manifold of the internal combustion engine.

As can be seen from the above, air filtration system 20 provides a number of enhancements to the air flow exiting the air filtration system. These enhancements include capturing airflow regardless of the position of the assembly, reversing airflow by 180 degrees (see recovery diffuser C), increasing airflow to the internal combustion engine (see combined air flows into filtration element D), accelerating air velocity at the entrance (see the structure at the top of air filtration system 20) and at the exit of the air filter (see the top of internal diffuser E); and recovering external airflow (see, for example, FIG. 7).

This invention has been described in terms of specific embodiments set forth in detail, but it should be understood that these are by way of illustration only and that the invention is not necessarily limited thereto. Modifications and variations will be apparent from this disclosure, drawings and appended claims, and maybe resorted to without departing from the skill of this invention, as those skilled in the art will readily understand. Accordingly, such variations and modifications of the disclosed product are considered to be within the purview and scope of this invention and the following claims.

What is claimed is:

1. An air filtration system for providing filtered air to an internal combustion engine, comprising:
an airflow inverter valve;
an internal diffuser;
a filtration element positioned between said airflow inverter valve and said internal diffuser; and
an external diffuser joined to said airflow inverter valve so as to at least partly surround said filtration element.

2. The air filtration system according to claim 1 further comprising:
a recovery diffuser adjacent said airflow inverter valve having a concave air flow guiding surface; and
said airflow inverter valve defines at least one opening allowing air flow deflected by said recovery diffuser to reach said filtration element.

3. The air filtration system according to claim 1 wherein said external diffuser defines at least one opening allowing air flow to communicate with said filtration element.

4. The air filtration system according to claim 1 further comprising at least one fin carried on the outer surface of said external diffuser.

5. The air filtration system according to claim 4 wherein said external diffuser defines at least one semiperforate hole adjacent said fin.

6. The air filtration system according to claim 4 wherein said external diffuser defines at least one through hole adjacent said fin.

7. The air filtration system according to claim 2 wherein said recovery diffuser is joined to said airflow inverter valve.

8. The air filtration system according to claim 2 wherein said recovery diffuser is removably joined to said airflow inverter valve.

9. The air filtration system according to claim 2 wherein said recovery diffuser defines a concave, generally annular airflow guide surface facing said airflow inverter valve so as to direct air flow toward said at least one opening defined by said airflow inverter valve.

10. The air filtration system according to claim 1 further comprising a structural body defining said airflow inverter valve at one end opposite said external diffuser at an opposed end.

11. The air filtration system according to claim 1 wherein said internal diffuser comprises a diffuser body having a first end for supporting said filtration element and a second opposed end for connection to said internal combustion engine.

12. The air filtration system according to claim 11 further comprising at least one fin carried on the outside of said diffuser body.

13. The air filtration system according to claim 1 wherein said second end of said diffuser body defines an exit passageway of reduced size compared to the first end of said diffuser body.

14. The air filtration system according to claim 10 wherein said airflow inverter valve defines a concave surface facing said filtration element and said external diffuser defines a generally frustoconical shape with a first smaller end joined to said airflow inverter valve and a second larger end adjacent said filtration element.

15. The air filtration system according to claim 2 further comprising a cap member carried by said airflow inverter valve and said recovery diffuser is removably joined to said cap member.

16. The air filtration system according to claim 15 wherein said recovery diffuser is adjustably movable toward and away from said cap member so as to be adjustably movable toward and away from said airflow inverter valve.

17. The air filtration system according to claim 1 wherein said airflow inverter valve defines at least one opening allowing air flow deflected by said recovery diffuser to reach said filtration element.

18. The air filtration system according to claim 1 wherein said airflow inverter valve, said internal diffuser, said filtration element and said external diffuser each have a central axis of rotation.

19. The air filtration system according to claim 18 wherein said central axes of rotation of said airflow inverter valve, said internal diffuser, said filtration element and said external diffuser are each aligned along a common central axis of said air filtration system.

20. The air filtration system according to claim 19 further comprising:
a recovery diffuser adjacent said airflow inverter valve having a concave air flow guiding surface;
said airflow inverter valve defines at least one opening allowing air flow deflected by said recovery diffuser to reach said filtration element; and
said recovery diffuser has a central axis of rotation aligned along said common central axis of said air filtration system.

21. The air filtration system according to claim 20 further comprising a cap member carried by said airflow inverter valve;
said recovery diffuser is removably joined to said cap member; and
said cap member has a central axis of rotation aligned along said common central axis of said air filtration system.

22. An air filtration system for providing filtered air to an internal combustion engine, comprising:
an airflow inverter valve;
an internal diffuser;
a filtration element held captive between said airflow inverter valve and said internal diffuser;
an external diffuser joined to said airflow inverter valve so as to at least partly surround said filtration element;
a recovery diffuser adjacent said airflow inverter valve having a concave air flow guiding surface; and
said airflow inverter valve defines at least one opening allowing air flow deflected by said recovery diffuser to reach said filtration element.

23. The air filtration system according to claim 22 wherein said airflow inverter valve, said internal diffuser, said filtration element, said recovery diffuser and said external diffuser each have a central axis of rotation.

24. The air filtration system according to claim 23 wherein said central axes of rotation of said airflow inverter valve, said internal diffuser, said filtration element, said recovery diffuser and said external diffuser are each aligned along a common central axis of said air filtration system.

25. An air filtration system for providing filtered air to an internal combustion engine, comprising:
an airflow inverter valve;
a cap member carried by said airflow inverter valve;
an internal diffuser;
a filtration element held captive between said cap member and said internal diffuser;
an external diffuser joined to said airflow inverter valve so as to at least partly surround said filtration element;
a recovery diffuser adjacent said airflow inverter valve having a concave air flow guiding surface, and
said airflow inverter valve defines at least one opening allowing air flow deflected by said recovery diffuser to reach said filtration element.
